(19) United States
(12) Patent Application Publication
(10) Pub. No.: US 2003/0061503 A1
(43) Pub. Date: Mar. 27, 2003

(54) Authentication for remote connections

(76) Inventors: Eyal Katz, Ramat Gan (IL); Ilan Zorman, Palo Alto, CA (US); Stuart Jeffery, Los Altos, CA (US); Yair Karmi, Rishon Le Zion (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 09/990,875

(22) Filed: Nov. 23, 2001

Related U.S. Application Data
(60) Provisional application No. 60/324,914, filed on Sep. 27, 2001.

(51) Int. Cl. G06F 11/30

(52) U.S. Cl. 713/200

(57) ABSTRACT

Apparatus and method for authentication of a user, the apparatus comprising functionality, associated with a cellular Internet authentication portal, for: communicating via a secure link with an authenticatable device, using secure personalization associated with said authentication portal and said authenticatable device, typically a mobile telephone having a SIM, to verify that the communication is with the intended user, and associating the authentication with an activity request via a non-authenticatable device, thereby to authenticate the activity request of the non-authenticatable device.

### RELATIONSHIP TO EXISTING APPLICATIONS

The present application claims priority from U.S. Provisional Application No. 60/324,914 filed Sep. 27, 2001, the contents of which are hereby incorporated by reference.

### FIELD OF THE INVENTION

The present invention relates to authentication for remote connections, for example for authenticating remote transactions or for ensuring that the correct user is billed for remotely provided services, and more particularly but not exclusively to providing authentication to users connecting over channels which are not secure or over which a user cannot be positively identified.

### BACKGROUND OF THE INVENTION

Currently there are numerous circumstances in which transactions are carried out without the physical proximity of the transacting parties. Such circumstances include ATM transactions, credit card and other transactions made by telephone, and transactions made over the Internet. Generally, the identity of the purchasing party is not established to a high degree in such transactions. The transactions are carried out over unsecured and/or non-authenticatable connections and using communication techniques that are insecure and/or non-authenticatable, allowing users to be impersonated and credit card numbers to be stolen.

Currently, arrangements for electronic payment rely very heavily on credit cards, which make it difficult to levy small charges, such as time charges for use of a network, or small charges for downloading of data items.

### SUMMARY OF THE INVENTION

According to a first aspect of the present invention there is thus provided authentication apparatus comprising:

a communicator for communicating with an authenticatable mobile device

a verifier associated with said authenticatable mobile device to verify that the communication is with an intended one of authenticatable devices, and

an associator for associating the verification with an activity request via a non authenticatable device, thereby to authenticate the activity request of the non-authenticatable device.

Preferably, said authenticable device is a GSM device and said authenticatable link is a GSM link.

Alternatively. said authenticatable device is a CDMA device and said authenticatable link is a CDMA link.

Alternatively, said authenticatable device is an IS-136 device and said authenticatable link is an IS-136 link

Alternatively, said authenticatable device is a PDC device and said authenticatable link is a PDC link.

Alternatively, said authenticatable device is an EDGE device and said authenticatable link is an EDGE link.

Alternatively, said authenticatable device is a WCDMA device and said authenticatable link is a WCDMA link, where the term WCDMA is intended to cover all CDMA technologies with wider bandwidth than IS-95: UMTS, 3xRTT and future developments.

Alternatively, said authenticatable device is a GPRS device and said authenticatable link is a GPRS link.

Alternatively, said authenticatable device is an Iridium device and said authenticatable link is an Iridium link.

Preferably, said secure link involves a subscriber identity module located at said secure mobile device. In the following description and claims, the term subscriber identity module refers to a SIM, USIM or to any other personalization device that contains personalized data.

Preferably, said authenticatable link is a secure link utilizing a subscriber identity module located at said authenticatable device.

Preferably, said authenticatable device is a mobile telephone, but alternatively it may be a personal digital assistant, portable computer or any other communication device that is able to maintain an authenticatable link..

Preferably, said communication comprises electronic data communication, such as electronic messaging including SMS format messages, and also WAP, EMS and MMS.

The communicator preferably comprises functionality to initiate said communication by sending an initial message to said authenticatable device and functionality to receive a reply to said initial message from said authenticatable device, therewith to authorize said activity request.

Preferably, the communicator comprises functionality to insert a password into said reply for a requesting party to enter via said non-authenticatable device, and wherein said verifier further comprises functionality to determine whether said password has been received via said non-authenticatable device.

Preferably, said communicator is operable to use an automatic voice for communicating with said authenticatable device.

Preferably, said authenticatable device is associated with a payment account, said apparatus further comprising functionality to charge said requested activity to said payment account.

Preferably, said requested activity is an Internet browsing activity.

Alternatively, wherein said requested activity is a point of sale activity.

Alternatively, said requested activity is access to a network, for control, transport or services provided within the network itself.

The network may typically comprise infra-red access points.

Alternatively, said network may comprise Bluetooth access points.

The apparatus is preferably connectable to said non-authenticatable device via a TCP/IP link.

Preferably, said communicator is operable to obtain a telephone number for communicating with said authenticatable device, from said non-authenticatable device.

Preferably, said non-authenticatable device is any one of a group comprising a credit card, a smart card, a Bluetooth device, an infra-red device, a PDA, a mobile computer, a fixed computer, and a network of computers.

The apparatus preferably comprises a counter for timing said communication to fail said authorization if said communication is not completed by a predetermined time limit. Alternatively or additionally, said apparatus comprises a counter to fail said authorization after a fixed or configurable number of unsuccessful login attempts.

The apparatus preferably comprises a log-in functionality for logging in the non-authenticatable device.

The apparatus preferably comprises charging record generation functionality, for generating billing records, or records for like uses.

The associator is preferably connected to an authentication communicator for indicating that said activity request is approved. The authentication communicator is operable to communicate said authentication to an external gateway associated with said non-authenticatable device.

Preferably, the authentication communicator is operable to communicate said authentication to a server associated with said requested activity.

Preferably, said authentication communicator is operable to communicate said authentication by applying a change to a routing table on a router, or to instruct another entity to apply such change, or to approve another entity to apply such a change, or to instruct another entity to prevent such a change, or to directly prevent such a change.

According to a second aspect of the present invention there is provided a personal transaction card compatible with ATM machines, comprising, in ATM readable format, an ATM routing number and a mobile telephone number, said mobile telephone number being associated with an owner of said personal transaction card.

Alternatively, the personal transaction card may be compatible with cellular SIM, USIM or other subscriber data storage devices.

Preferably, said numbers are stored on a magnetic strip.

Alternatively, said numbers are stored in an internal integrated circuit.

According to a third aspect of the present invention there is provided an authentication method comprising:

communicating via a secure link with an authenticatable device,

verifying that the communication is with an intended one of authenticatable devices, and

associating the verification with an activity request via a non-authenticatable device, thereby to authenticate the activity request of the non-authenticatable device.

The method preferably comprises initiating said communication by sending an initial message to said authenticatable device and functionality to receive a reply to said initial message from said authenticatable device, therewith to authorize said activity request.

Alternatively, the authenticatable device may send the initial message to the communicator authorizing said activity, before or after the non-authenticatable device attempts to access the service. The reply may then contain an identifier to be used by the non-authenticatable device.

Preferably, said communicating involves receiving a message from said authenticatable device and completing said communication by sending a response thereto to said authenticatable device, thereby to authorize said activity request.

The method preferably comprises inserting a password into said reply for a requesting party to enter via said non-authenticatable device, and determining whether said password has been received via said non-authenticatable device.

The method preferably comprises using an automatic voice for communicating with said authenticatable device.

Preferably, said authenticatable device is associated with a payment account, said method further comprising charging said requested activity to said payment account.

The method preferably comprises obtaining a telephone number for communicating with said authenticatable device, from said non-authenticatable device.

Preferably, the non-authenticatable device is any one of a group comprising a credit card, a smart card, an infra-red device, a Bluetooth device, a PDA, a mobile computer, a fixed computer, an interactive television device and a network of computers.

The method preferably comprises timing said communication to fail said authorization if said communication is not completed by a predetermined time limit.

The method preferably comprises carrying out a logging in procedure with the non-authenticatable device to start a session with a network or a content server etc.

The method preferably comprises outputting an indication that said activity request is approved.

Preferably, said indication is output to an external gateway associated with said non-authenticatable device.

Preferably, said indication is output to a server associated with said requested activity.

Preferably, said indication is output by applying a change to a routing table on a router.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified block diagram showing an authentication mechanism according to a first preferred embodiment of the present invention,

FIG. 2 is a simplified pictorial diagram showing a device for use in the secure link of FIG. 1,

FIG. 3 is a simplified pictorial diagram showing a device for use in the insecure link of FIG. 1,

FIG. 4 is a simplified block diagram showing another embodiment of an authentication mechanism according to the present invention, specifically for allowing controlled access to a wired or wireless LAN, and

FIG. 5 is a simplified flow chart showing operation of the authentication mechanism of FIG. 1, where the setup may start from any device, secure or unsecured, including setup from a different device.

### DESCRIPTION OF THE PREFERRED EMBODIMENTS

Mobile communication provides a high degree of personalization. For example, GSM phones provide a SIM card which provides each user with personalized communication associated with his/her account with his/her mobile telephone service provider. CDMA based mobile also entails similar personalization. In accordance with the embodiments of the present invention, a user is enabled to set up a transaction over any unsecured or secured means at his disposal, following which the transaction is confirmed or authorized via his/her mobile telephone. Authorization may for example be via an SMS message sent to his mobile telephone to which he sends a simple reply. Alternatively, the user may send an SMS message from his own mobile telephone to a number indicated to him. The transaction may then be charged to the mobile telephone account. The advantage of charging to a mobile telephone account is that, unlike credit card and like other accounts, the telephone account is uniquely set up for charging small amounts at a time. The embodiments thus provide a means of providing low cost products and services on the Internet, previously made difficult because of minimum charges by credit card companies.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

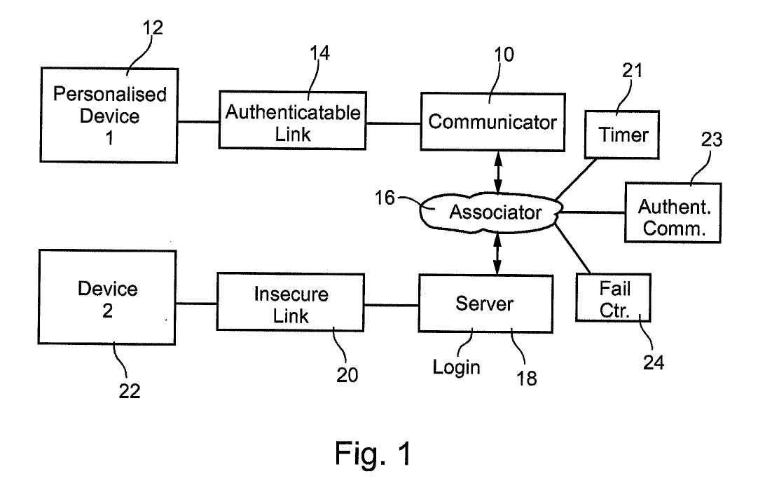

Reference is now made to FIG. 1, which is a simplified block diagram showing an authentication mechanism according to a first preferred embodiment of the present invention. In FIG. 1, there is shown a communicator 10, typically part of a cellular Internet portal including an SMS portal. Optionally this Internet portal may include a WAP portal, in addition to or instead of the SMS portal. The communicator is able to communicate with a first personalized device 12 via an authenticatable link 14 such as a GSM or CDMA link as well as any extension thereof (GPRS, UMTS, etc.). GSM etc, links provide not only authentication but also encryption, which is preferred but is not a requirement of the present invention. A basic embodiment requires only authentication and non-repudiation of the transmission. Generally, the communication is a digital communication such as an SMS or GPRS data message, although, as will be explained below, voice can also be used.

The communication preferably takes advantage of user authentication, which is a feature of GSM or CDMA. Additional authentication can be provided by a link 14 and the device 12, additionally supporting encryption. The personalization preferably enables the first personalized device to be positively identified. In addition there is provided an associator 16, which is able to carry out the positive identification of the first personalized device 12 and to associate the authentication with a separate activity or request for activity received by a server 18 or like device through an non-authenticatable link 20 from a requesting device 22. In the present context, a non-authenticatable link is a link through which users or requesting devices cannot be positively identified, and particularly includes general Internet connections. The inability to identify the requesting device may be due to there being no strong authentication mechanism such a SIM card, or because the link itself is insecure, allowing eavesdropping and impersonation or for any other reason.

The mechanism of FIG. 1 thus solves the problem of the insecure link by requiring an extra leg of communication via an authenticable link. Generally, mobile telephone devices are authenticable personalized devices, and by requiring an extra leg of the communication via a mobile telephone link, a provider can determine that a request is genuine. In addition, the mobile telephone is associated with a charging account, and provision is made to allow for billing to be directed to the customer thus identified. As will be explained below, the authenticatable link leg of the communication may precede or follow the non-authenticatable leg, as long as the two legs can be successfully associated, and a non-exhaustive list of alternative procedures is described hereinbelow. Of course, the invention is not limited to mobile telephones and any securely personalized device that communicates over a secure link such that it cannot be impersonated may be used.

The associator 16 is preferably connected to an authentication communicator 23 for indicating to the server 18 that a given activity request is approved. Alternatively, the authentication communicator 23 may communicate the authentication to an external proxy server or gateway associated with the non-authenticatable device. As a further alternative, the authentication communicator may communicate the authentication to any device or network node responsible for managing the activity which is the subject of the request. In a further embodiment, the authentication communicator 23 may communicate the authentication by applying a change to a routing table on a router.

In addition to GSM and CDMA, a non-exhaustive list of other systems currently available that provide secure links includes IS-136, PDC, EDGE, WCDMA, GPRS, Iridium, and GlobalStar. The term CDMA covers the IS-95 standard and the 2.5 and 3G versions thereof are known respectively as 1XRTT and 3XRTT.

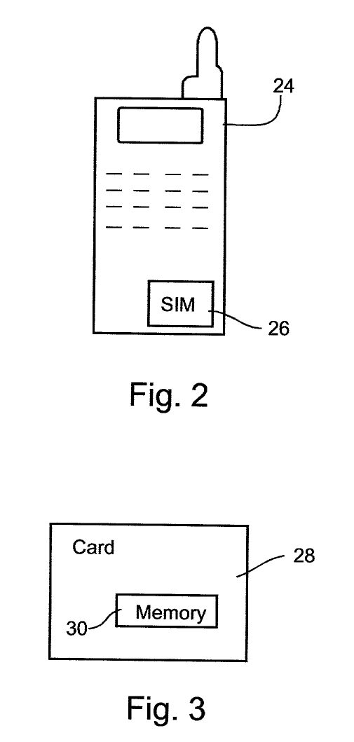

Reference is now made to FIG. 2, which is a simplified diagram showing a GSM device 24 such as a mobile telephone. The GSM device comprises a SIM which consists of one or more integrated circuits where at least one of those contains personalized data that supports authentication, encryption and decryption for the secure link 14. The SIM both identifies the mobile telephone and makes it impossible for other devices to impersonate that telephone, thus providing authentication and secure access to a charge account corresponding to the respective mobile telephone user.

Although in the above, the assumption has been that the messaging itself is data messaging, the invention is in no way limited thereto. The secure link 14 is also secure for voice communication and it is possible to provide automatic voice message construction functionality at the communicator 10 to construct messages from pre-recorded message sections. Additionally it is possible to provide an artificial voice. Either way a voice message may be sent to the personalized device over the secure link. The voice message may for example identify the transaction and may request that the user presses one of the keys by way of an affirmative reply.

In a particularly preferred embodiment of the present invention, a device corresponding to a potential user of a service requests the service via the insecure link 20. The insecure link 20 may be any kind of network, particularly an open network such as the Internet, or other digital or analogue networks, and may include a LAN, a Wireless LAN (WLAN), in particular any WLAN corresponding to the IEEE 802.11 standards, including 802.11, 802.11b, 802.11a . . . g, etc.

During the log-in process it identifies its secure link, for example by giving an associated mobile telephone number. The identification may be retrieved from storage or entered manually by the user. The associator 16 receives the identification (e.g. mobile telephone number). It may need to translate the received identification into a different identification appropriate to the communicator 10, and the translation may be carried out by the associator 16 itself or through external translation services, for example by accessing a home location register (HLR). The associator 16 then uses the communicator 10 to contact the mobile telephone in any appropriate way. A timer 23 is operated, giving the owner of the mobile telephone a fixed time to reply and confirm the identity of the user. Additionally or alternatively, a failure counter 24 counts unsuccessful attempts to establish the authentication, stopping the authentication operation when a predetermined threshold is reached.

In an alternative embodiment the operation is initiated both at the non-authenticatable device 22, which makes contact with the server 18 and at the personalized device 12, which makes contact with the communicator 10. The associator 16 makes a link between the two communications, and the service to the non-authenticatable device is authorized. One way of assuring that the authorization by the user was not inadvertent is to provide a password in the reply to the authenticatable device 12. The password is then entered by the user at the non-authenticatable device 22, thus making clear that the user of the non-authenticatable device 22 is the same as the user of the authenticatable device and that this action is intentional. If such a password embodiment is used, the authenticating link is preferably encrypted, so as not to reveal the password. Alternatively the password may only be used a limited number of times, for example only once, in which case the authenticating link need not be encrypted.

As will be explained below, since the log-on name used by the non-authenticatable device is the MSISDN, that is to say the mobile telephone number, it is possible for fraudulent users to probe different MSISDN values. Such probes may cause the mobile phone to receive a request for service and, if the user is not vigilant, the user could inadvertently authorize service for these fraudulent users. The problem may be reduced by requiring the non-secure device to use a password, in addition to the MSISDN. An alternative solution starts the authentication sequence from the Mobile Unit: The user sends an SMS to the communicator, which in turn responds to the mobile with a temporary password for the session. The user uses the PDA or other non-authenticatable device to connect, via the Internet, to the server 18, and enters his user name (MSISDN) and the temporary password. Alternatively, the communicator provides a temporary identifier and password pair, to ensure user anonymity and the user enters this temporary identifier and password pair.

Transfer of the identifiers from the authenticatable device to the non-authenticatable device may be manual or through some local wired or wireless communication link.

The associator or communicator recognize the access data provided, such as the temporary password and identity, as associated with the MSISDN and service is authorized.

Preferably, in such an embodiment, SMS transmissions are completed prior to the logon sequence of the mobile terminal (PDA, laptop, etc.) being started.

As a further alternative to the above, the SMS may comprise a quasi-random number, which the user is required to copy or that is otherwise transferred into his non-authenticatable device to complete the authentication, thereby reducing the risk of inadvertent authentication.

The requested activity may be an Internet browsing activity. Use of the secure link, which is associated with a charging account, allows for small amounts to be charged, hitherto a problem with Internet browsing which has tended to rely on credit cards. The requested activity may be the browsing itself, or it may include activities associated with browsing such as purchasing, using pay services, etc. Thus the user may arrive at an Internet bookstore or the like and make a purchase by entering his mobile telephone number rather than his credit card number. He then receives a message on his mobile telephone and replies to that message to complete the transaction. The Internet activity may additionally be ftp type activity or an activity that does not involve browsing, such as streaming data based applications, email, etc.

In an alternative embodiment, the non-authenticatable device 22 may be a credit card or a smart card and the requested activity may be a point of sale activity such as use of an ATM. In this connection, reference is made to FIG. 3, which is a simplified diagram showing a card 28, such as a smart card or credit card, with a memory unit 30. The memory unit 30 may be part of an integrated circuit as with a smart card, or it may be a magnetic strip as with a conventional credit card. Preferably, the memory unit 30 comprises the standard transaction information such as an ATM number, and in addition a further number that allows for identification of the mobile telephone number. In one embodiment, the number encoded on the card is the mobile telephone number, however this has the disadvantage that a false telephone number could be entered. In another embodiment the further number is an encoded version of the mobile telephone number. The encoded version could be an enciphered version, in which a function is available to decipher the telephone number. Alternatively, a code could be used, which is simply an entry in a lookup table. The latter version is particularly secure since a hacker can only substitute a different telephone number if he knows its code in the lookup table. The user enters his card into the ATM in the normal way. The card transfers the user's telephone number, or a code related to it, which is used to generate a call to the user's mobile telephone. The user completes the transaction by replying to the mobile telephone or by entering into the ATM a uniquely generated PIN number provided in the communication. In a preferred embodiment; the user both replies and enters the PIN number.

The requested activity may for example be access to a network, that is to say the user requests access to a LAN or to the Internet or the like. It thus enables the provision of roaming Internet, the ability to log on to the Internet using local resources when traveling and not in the proximity of one's own Internet provider.

In particular, the network to which access may be requested may be a network accessed via Wireless LAN access points or infra-red access points or via Bluetooth access points. The idea of Wireless LAN or infra-red or Bluetooth is to provide flexible network access to all devices in proximity of the access points and the present embodiments allow for potential users to be identified and charged for the service.

As discussed above, the communicator preferably obtains a telephone number, in either plaintext, or as an encoded or enciphered version of the telephone number from the non-authenticatable device. The number is preferably used for establishing a communication with the secure mobile device. However, in those embodiments in which communication is initiated from the secure mobile device, the telephone number is preferably used to associate the secured and non-authenticatable links that have already been established.

In accordance with the above, the non-authenticatable device may be a credit card, a smart card, an infra-red device, a Bluetooth device, a PDA, a wearable computer, a mobile computer, a fixed computer, and a network of computers or any other device that is able to establish a communication using infra-red or Bluetooth or Wireless LAN or HomeRF or wired or any other type of communication.

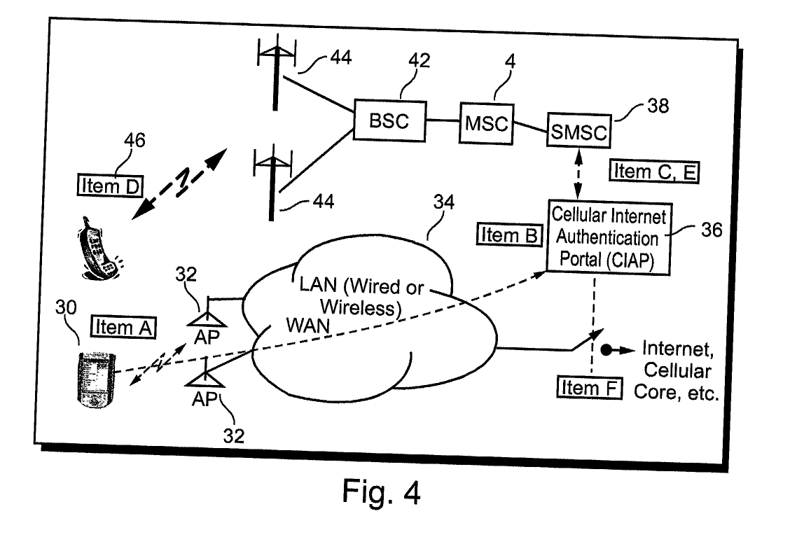

Reference is now made to FIG. 4 which is a simplified block diagram showing a further embodiment of verification apparatus according to the invention, with component parts shown in greater detail. A non-authenticatable device such as a PDA 30 communicates wirelessly via network access points 32, to a LAN/WAN 34, which itself may be wired or wireless. The LAN may be connected directly (or indirectly) to a cellular Internet authentication portal 36, and may be a means of providing the user with access to the Internet or any other data network or services. The portal 36 preferably appears to the PDA 30 as a standard Internet authentication device to which it logs in as normal. The login process can be carried out manually or can be automated as desired. The number of the user's mobile telephone may be supplied as the login username or as a separate part of the login procedure. The portal begins to run a timer to timeout the authentication after a predetermined time limit. Optionally the portal may also set up a counter to limit the number of login attempts to reduce the risk of hacking. The portal is connected directly or indirectly to a short message service center SMS-C 38, the network element that manages SMS messaging. The SMS-C 38 sends an SMS message via MSC 40, BSC 42 and cellular base stations 44 to SIM protected mobile telephone 46. The user thus receives a request telling him to press reply in order to activate his network connection. In a further enhancement, the user may be asked to provide a password. The SMS itself is usually encrypted and the SIM supports authentication to make it clear that it is only the intended mobile telephone that is replying. The mobile telephone replies to the SMS. All SMS messages have an address of origin, which is usually not passed on in Internet-based SMS. In order to enable a reply, the SMS message as sent may be provided with a telephone number of the authenticator to allow a reply to reach the authenticator. The user is then authorized to access the Internet or other data network via the LAN and his use of the LAN may then be charged to his mobile telephone.

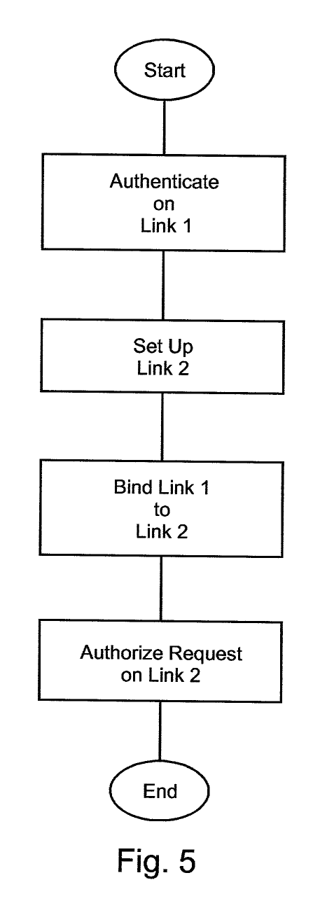

Reference is now made to FIG. 5, which is a simplified flow chart showing verification of a non-authenticatable channel via an authenticatable channel according to an embodiment of the present invention. In FIG. 5, authenticating the link comprises steps of communicating via an authenticatable link with an authenticatable device, verifying, using the authentication procedures of the link, that the communication is with an intended mobile device, setting up a second link via a non-authenticable second channel or link. A stage follows of binding or associating the verification with an activity request via a non-authenticatable device. Once the two channels or links have been bound then the authentication on the one link may be used to allow the request on the other link, as explained above, thereby to permit the activity request of the non-authenticatable device. The step of binding may be carried out by use of an identifying telephone number provided by the non-authenticatable device. The step of authenticating preferably includes sending a message to the authenticatable mobile device, to which a reply is expected as explained above.

As discussed above, it is not crucial to the invention which of the two links is made first or whether they are made simultaneously. Each possibility provides a legitimate embodiment of the invention with attendant advantages and disadvantages.

In one version, communication starts with the non-authenticable device. The system sends a message to the related authenticatable device requesting approval. The device user sends back his approval and either the authentication is completed at that point or the system sends a password to the authenticatable device. The user receives the password and enters or copies or otherwise transfers the password to the non-authenticatable device, thus to complete the authentication.

In another version, a communication request originates from the authenticatable device. The system sends a password or temporary username and password to the authenticable device. The password, or username and password, is copied or transferred to the non-authenticatable device, and the non-authenticable device relays the password etc. back to the system to establish the authentication.

The above procedures are only used on initial communication establishment, or in a particularly preferred embodiment only on an initiating communication. Thereafter, a secure communication channel is established between the system and the non-authenticatable device using additional identity/ identities provided to access the system the next time(s). During future accesses, the system adds additional identities/ passwords, with optional notification to the authenticatable device. Such a preferred embodiment saves the delay needed to set up the authenticable channel with the authenticatable device, after the first communication.

In the preferred embodiment, the authentication method does not require any special hardware or software to be installed on the PDA 30. The PDA works with a standard browser and standard network interface units.

In an alternative embodiment, software is installed to support the defined processes and assist in or save manual user actions such as entry of addresses and transfer of data between the authenticatable and non-authenticatable units.

The subscriber does not need to learn any new numbers or passwords, and the mobile phone number (MSISDN) may be provided as a user name.

The mobile terminal 46 is a standard authenticable unit. The terminal may be voice only, SMS only, WAP only, GPRS only, 3G only, any other data communication standard or a combination.

Authorization for the requested service requires possession of the user specific SIM or USIM or similar device., thus binding the service to the SIM or USIM or similar device.

The service need not be provided with any special provisioning database. The user identification is the MSISDN or similar identifier (such as IMSI). No new passwords are required to be provided for or memorized by the user. However, an alternative embodiment requires provision of data bases, for example when used with a RADIUS Server. A RADIUS server is a server used to authenticate users who access a communication system, which authentication is based on the RADIUS or remote authentication dial-in user server protocol.

A single network server 22 may be used to support many carriers.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

There is thus provided an authentication system which comprises the use of a mobile telephone secure channel to securely transfer an authorization code that may be used to authorize some other service.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Authentication apparatus comprising:
a communicator for communicating with an authenticatable mobile device,
a verifier associated with said authenticatable mobile device to verify that the communication is with an intended one of authenticatable devices, and
an associator for associating the verification with an activity request via a non authenticatable device, thereby to authenticate the activity request of the non-authenticatable device.

2. The apparatus of claim 1, wherein said authenticable device is a GSM device and said authenticatable link is a GSM link.

3. The apparatus of claim 1, wherein said authenticatable device is a CDMA device and said authenticatable link is a CDMA link.

4. The apparatus of claim 1, wherein said authenticatable device is an IS-136 device and said authenticatable link is an IS-136 link.

5. The apparatus of claim 1, wherein said authenticatable device is a PDC device and said authenticatable link is a PDC link.

6. The apparatus of claim 1, wherein said authenticatable device is an EDGE device and said authenticatable link is an EDGE link.

7. The apparatus of claim 1, wherein said authenticatable device is a WCDMA device and said authenticatable link is a WCDMA link.

8. The apparatus of claim 1, wherein said authenticatable device is a GPRS device and said authenticatable link is a GPRS link.

9. The apparatus of claim 1, wherein said authenticatable device is an Iridium device and said authenticatable link is an Iridium link.

10. The apparatus of claim 1, wherein said secure link involves a subscriber identity module located at said secure mobile device.

11. The apparatus of claim 1, wherein said authenticatable link is a secure link utilizing a subscriber identity module located at said authenticatable device.

12. The apparatus of claim 1, wherein said authenticatable device is a mobile telephone.

13. The apparatus of claim 1, wherein said communication comprises an electronic data communication.

14. The apparatus of claim 13, wherein said electronic data communication comprises electronic messaging.

15. The apparatus of claim 14, wherein said electronic messaging comprises SMS messaging.

16. The apparatus of claim 14, wherein said electronic messaging comprises WAP.

17. The apparatus of claim 14, wherein said electronic messaging comprises email.

18. The apparatus of claim 14, wherein said electronic messaging comprises EMS.

19. The apparatus of claim 14, wherein said electronic messaging comprises MMS.

20. The apparatus of claim 14, wherein said communicator comprises functionality to initiate said communication by sending an initial message to said authenticatable device and functionality to receive a reply to said initial message from said authenticatable device, therewith to authorize said activity request.

21. The apparatus of claim 14, wherein said communicator comprises functionality to receive an initializing communication from either one of said authenticatable device and said non-authenticatable device, and functionality to send a reply to said initial message, therewith to authorize said activity request.

22. The apparatus of claim 14, wherein said communicator comprises functionality to receive an initializing communication from an external device and functionality to establish a link between said authenticatable device and said non-authenticatable device, therewith to authorize said activity request.

23. The apparatus of claim 14, wherein said communicator involves functionality to receive a message from said authenticatable device and functionality to complete said communication by sending a response thereto to said secure authenticatable device, thereby to authorize said activity request.

24. The apparatus of claim 20, wherein said communicator comprises functionality to insert an identifier into said reply for a requesting party to enter via said non-authenticatable device, and wherein said verifier further comprises functionality to determine whether said identifier have been received via said non-authenticatable device.

25. The apparatus of claim 1, wherein said communicator is operable to use an automatic voice for communicating with said authenticatable device.

26. The apparatus of claim 1, wherein said authenticatable device is associated with a payment account, said apparatus further comprising functionality to charge said requested activity to said payment account.

27. The apparatus of claim 1, wherein said requested activity is an Internet browsing activity.

28. The apparatus of claim 1, wherein said requested activity is a point of sale activity.

29. The apparatus of claim 1, wherein said requested activity is access to a network.

30. The apparatus of claim 29, operable to connect to said non-authenticable device via infra-red access points.

31. The apparatus of claim 1, operable to connect to said non-authenticable device via Bluetooth access points.

32. The apparatus of claim 1, operable to connect to said non-authenticatable device via at least one WVLAN access point.

33. The apparatus of claim 1, being connectable to said non-authenticatable device via a TCP/IP link.

34. The apparatus of claim 1, wherein said communicator is operable to obtain a telephone number for communicating with said authenticatable device, from said non-authenticatable device.

35. The apparatus of claim 1, wherein said communicator is operable to obtain identification data, from said non-authenticable device, for forming said association.

36. The apparatus of claim 1, wherein said non-authenticatable device is any one of a group comprising a credit card, a smart card, an infra-red device, a Bluetooth device, a PDA, a mobile computer, a fixed computer, and a network of computers.

37. The apparatus of claim 1, further comprising a counter for timing said communication to fail said authorization if said communication is not completed by a predetermined time limit.

38. The apparatus of claim 1, further comprising a log-in functionality for logging in the non-authenticatable device.

39. The apparatus of claim 1, wherein said associator is connected to an authenticator for indicating that said activity request is approved.

40. The apparatus of claim 39, wherein said authentication communicator is operable to communicate said authentication to an external gateway associated with said non-authenticatable device.

41. The apparatus of claim 39, wherein said authentication communicator is operable to communicate said authentication to a server associated with said requested activity.

42. The apparatus of claim 39, wherein said authentication communicator is operable to communicate said authentication by applying a change to a routing table on a router.

43. A personal transaction card compatible with ATM machines, comprising, in ATM readable format, an ATM routing number and a mobile telephone number, said mobile telephone number being associated with an owner of said personal transaction card.

44. The personal transaction card of claim 43, wherein said numbers are stored on a magnetic strip.

45. The personal transaction card of claim 43, wherein said numbers are stored in an internal integrated circuit.

46. Authentication method comprising:
communicating via a secure link with an authenticatable device,
verifying that the communication is with an intended one of authenticatable devices, and
associating the verification with an activity request via a non-authenticatable device, thereby to authenticate the activity request of the non-authenticatable device.

47. The method of claim 46, wherein said authenticatable device is a GSM device and said authenticatable link is a GSM link.

48. The method of claim 46, wherein said authenticatable device is a CDMA device and said authenticatable link is a CDMA link.

49. The method of claim 46, wherein said authenticatable device is an IS-136 device and said authenticatable link is an IS-136 link.

50. The method of claim 46, wherein said authenticatable device is a PDC device and said authenticatable link is a PDC link.

51. The method of claim 46, wherein said authenticatable device is an edge device and said authenticatable link is an edge link.

52. The method of claim 46, wherein said authenticatable device is a WCDMA device and said authenticatable link is a WCDMA link.

53. The method of claim 46, The method of claim 46, wherein said authenticatable device is a GPRS device and said authenticatable link is a GPRS link.

54. The method of claim 46, wherein said authenticatable device is an Iridium device and said authenticatable link is Iridium link.

55. The method of claim 46, wherein said authenticatable link comprises a secure link involving a subscriber identity module located at said authenticatable device.

56. The method of claim 47, wherein said secure link involves a subscriber identity module located at said authenticatable device.

57. The method of claim 46, wherein said authenticatable device is a mobile telephone.

58. The method of claim 46, wherein said communication comprises electronic data communication.

59. The method of claim 58, wherein said electronic data communication comprises electronic messaging.

60. The method of claim 59, wherein said electronic messaging comprises SMS messaging.

61. The method of claim 60 comprising initiating said communication by sending an initial message to said authenticatable device and functionality to receive a reply to said initial message from said authenticatable device, therewith to authorize said activity request.

62. The method of claim 60, wherein said communicating involves receiving a message from said authenticatable device and completing said communication by sending a response thereto to said authenticatable device, thereby to authorize said activity request.

63. The method of claim 62, comprising inserting a password into said reply for a requesting party to enter via said non-authenticatable device, and determining whether said password has been received via said non-authenticatable device.

64. The method of claim 46, comprising using an automatic voice for communicating with said authenticatable device.

65. The method of claim 46, wherein said authenticatable device is associated with a payment account, said method further comprising charging said requested activity to said payment account.

66. The method of claim 46, wherein said requested activity is an Internet browsing activity.

67. The method of claim 46, wherein said requested activity is a point of sale activity.

68. The method of claim 46, wherein said requested activity is access to a network.

69. The method of claim 46, comprising using infra-red.

70. The method of claim 46, comprising using bluetooth.

71. The method of claim 46, said non-authenticatable device being a TCP/IP link.

72. The method of claim 46, comprising obtaining a telephone number for communicating with said authenticatable device, from said non-authenticatable device.

73. The method of claim 46, wherein said non-authenticatable device is any one of a group comprising a credit card, a smart card, an infra-red device, a Bluetooth device, a PDA, a mobile computer, a fixed computer, and a network of computers.

74. The method of claim 46, further comprising timing said communication to fail said authorization if said communication is not completed by a predetermined time limit.

75. The method of claim 46, further comprising a logging in procedure for logging in the non-authenticatable device.

76. The method of claim 46, comprising outputting an indication that said activity request is approved.

77. The method of claim 76, wherein said indication is output to an external gateway associated with said non-authenticatable device.

78. The method of claim 76, wherein said indication is output to a server associated with said requested activity.

79. The method of claim 76, wherein said indication is output by applying a change to a routing table on a router.
